(19) United States
(12) Patent Application Publication
(10) Pub. No.: US 2001/0051209 A1
(43) Pub. Date: Dec. 13, 2001

(54) SUPPRESION OF VOLTAGE BREAKDOWN AND FIELD EMISSION FROM SURFACES

(76) Inventors: RICHARD SILBERGLITT, FAIRFAX, VA (US); WILLIAM PETER, ROCKVILLE, MD (US)

Correspondence Address: ANSEL M SCHWARTZ, ONE STERLING PLAZA, 201 NORTH CRAIG STREET, SUITE 304, PITTSBURGH, PA, 15213

(21) Appl. No.: 08/730,475

(22) Filed: Oct. 11, 1996

(51) Int. Cl. B05D 5/12; B05D 1/36

(52) U.S. Cl. 427/77; 427/78; 427/124; 427/405

(57) ABSTRACT

This invention consists of a coating applied to the metal surface which reduces the field emission levels of the surface. This coating could also decrease the secondary electron coefficient of the surface. The preferred embodiment described below is a hybrid coating consisting of two layers. However, a single-layer coating may also be used so long as it decreases field emission. Likewise, any number of coating layers may be used, so long as the resultant coating reduces field emission. The coating may also alter the properties of the interface between the metal surface and any macroparticle debris, in order to reduce field emission levels, but this is not essential, so long as the field emission from the surface is reduced. The invention is a coating which is not harmful to dc and rf vacuum system components, as for example, coatings which contain halogen atoms, such as CaF [J. N. Smith, Jr., J. Appl. Phys. 59, 283 (1986)]. This invention provides a means of raising breakdown thresholds in rf cavities even in non-multipactor parameter regimes. The coating can reduce emission from the electrodes by isolating the electrode surface whiskers from the cavity vacuum (FIG. 1). It can also absorb low-energy secondary or field-emitted electrons. We have obtained voltage holdoff data and dark current measurements for a variety of coatings, two of which far exceed the properties of the current state-of-the-art Titanium Nitride (TiN) coatings. For example, DC electrical breakdown is increased from a value of 40 MV/m for bare Copper to 115 MV/m for a copper electrode coated as described in the preferred embodiment. TiN-coated electrodes undergo DC breakdown at a much lower value of 50 MV/m. Dark current levels from the coating described in the preferred embodiment are over six orders of magnitude less than TiN-coated Copper even after arcing. These coatings have been demonstrated to have the properties required for use in high-voltage holdoff applications. For example, they can decrease the secondary emission yield, are mechanically stable, are not sensitive to radiation, are bakeable (important since most vacuum electronic systems are baked before use to eliminate contaminants), do not affect the cavity Q (the ability of the cavity to store energy), and will not poison a cathode. The present invention pertains to a method of suppressing electrical breakdown on a surface of an object to reduce field emission. The method comprises the steps of applying a first coating layer coating to the surface; and applying at least one subsequent coating layer which does not cause cathode contamination to the surface over the first coating layer. The present invention pertains to a device comprising a component having a surface, a first layer in contact and covering the surface which has a dark current emission less than that of bare copper and a voltage breakdown threshold higher than 40 MV/m DC.

### FIELD OF THE INVENTION

The present invention is related to a method for suppressing voltage breakdown and dark current from surfaces subject to electric fields. This coating technology can suppress high-voltage breakdown and can lower the dark current levels by many orders of magnitude. It is a simple way to suppress high-voltage breakdown in consumer, military, and research devices and products.

### BACKGROUND OF THE INVENTION

Electrical breakdown is a serious constraint since it limits the gradient that can be practically maintained on an electrode surface. Conventional devices that use high-voltage vacuum insulation often rely on expensive or impractical solutions to suppress breakdown. These include sophisticated polishing of the electrodes, imposing transverse magnetic fields, or redesigning the cavity for larger electrode separation [R. V. Latham, Phys. Techol. 9, 20 (1978).].

On some surfaces, high-voltage breakdown at radio frequencies (rf) is directly attributable to particle multipacting [S. O. Schriber, IEEE Trans. Nuc. Sci. NS-28, 3440 (1981); P. T. Farnsworth, J. Franklin Inst. 218, 411 (1934)]. Multipacting is an electron resonance phenomenon which can exist in radio frequency cavities such that the number of ambient electrons can grow without limit. Multipacting can only occur if the cavity electrodes are made from a material whose secondary emission coefficient is larger than unity. The secondary emission coefficient is the number of secondary electrons that are released from a surface per primary electron impact. In such cases, carbon-based electrode coatings made from pyrolytic graphite or lamp black are used (A. A. Dorofeyuk, I. A. Kossyi, G. S. Luk'yanchikov, and M. M. Savchenko, Zh. Tekh. Fiz. 46, 138 (1976). [Sov. Phys. Tech. Phys. 21, 79 (1976)]; D. Ruzic, R. Moore, D. Manos, and S. Cohen, J. Vac. Sci. Technol. 20, 1313 (1982)]. The principle here is to superimpose a surface whose secondary emission coefficient is less than unity over an electrode surface with a high secondary emission ratio. For example, titanium-based coating films have proved successful in suppressing electron multipacting in high-power microwave tubes at the Stanford Linear Accelerator Center [R. W. Bierce, J. Jasberg, and J. V. Lebacqz in The Stanford Two-Mile Accelerator, edited by R. B. Neal (Benjamin, N.Y., 1968), Ch. 10].

In most microwave cavities, rf vacuum breakdown occurs at voltages much higher than the limit for electron multipacting, and at much lower voltages than would be expected if field emission were the mechanism for its initiation. As described by W. P. Dyke and J. K. Trolan, Phys. Rev. 89, 799 (1953), breakdown occurs when the local electric field at a given surface microprotrusion (or “whisker”) is raised to a high enough value that field emission occurs. The resultant high current densities cause resistive heating and vaporization of the whisker [W. P. Dyke and J. K. Trolan, Phys. Rev. 89, 799 (1953); D. Alpert, D. A. Lee, E. M. Lyman, and H. E. Tomaschke, J. Vac. Sci. Technol. 1, 35 (1964)].

The extent of conditioning of the electrode surfaces is a factor in breakdown voltage levels [D. Boehne, W. Karger, E. Miersch, W. Roske, and B. Stadler, IEEE Trans. on Nucl. Sci. 18, 568 (1971)]. Conditioning is achieved by low current glow discharges, repeated sparking, or gradual increases in the applied voltage. Reduced electron emission from conditioning may be due to the polymerization of adsorbed hydrocarbons on the electrode surface [J. Halbritter, J. Appl. Phys. 53, 6475 (1982)]. Such layers produce strong inelastic scattering for slow electrons, effectively reducing the secondary emission and field emission from excited states. Conditioning could also be responsible for blunting the micron-length whiskers that grow on metal surfaces when high voltages are applied.

Electrical breakdown may also result from high-energy ion bombardment [J. G. Trump and R. J. Van de Graaf, J. Appl. Phys. 18, 327 (1947). Electron emission from the cathode and ion emission from the anode can initiate a cascade process by means of secondary emission. Dyke and Trolan [W. P. Dyke and J. K. Trolan, Phys. Rev. 89, 799 (1953)] demonstrated that breakdown occurred between electrodes when the average current density exceeded some critical value, even under the best initial conditions of vacuum and surface cleanliness.

Sometimes vacuum breakdown occurs at much lower voltages than would be expected if field emission alone were the mechanism for initiation [W. D. Kilpatrick, Rev. Sci. Inst. 28, 824 (1957)]. Because of this, the increase in emission due to energetic ion bombardment was included in a phenomenological criterion for vacuum breakdown by Kilpatrick [W. D. Kilpatrick, Rev. Sci. Inst. 28, 824 (1957)].

Recent studies on field emission and high-voltage breakdown suggest that emission over a surface is observed to occur from isolated sites [R. J. Noer, in Proc. of the 6th Workshop on rf Superconductivity, CEBAF Technical Report, October 1993, R. M. Sundelin, Ed., p. 236]. These sites have been shown to be made up of micron-size metallic contaminant particles which are responsible for field emission. Not all the metallic contamination on an electrode surface participates in field emission, but the bulk of field emission is due to this metallic debris. Contaminant particles are particularly good strong emitters since they are Th irregularly shaped (R. J. Noer, in Proc. of the 6th Workshop on rf Superconductivity, CEBAF Technical Report, October 1993, R. M. Sundelin, Ed., p. 236]. In addition to micron-size metallic “flakes”, surface craters (or several groups of such craters) can act as a field emission site [H. Padamsee and J. Knobloch, “Issues in Superconducting RF Technology,” to be published in Proc. of the Joint U.S.-CERN-KEK Accelerator School-1994, World Scientific Press] and the interface between the contaminant macroparticle and the substrate can play an important role. Heating an emission-free Nb surface to temperatures between 200° C. and 600° C. converts non-emitting contaminants into emitters [E. Mahner, in Proc. of the 6th Workshop on rf Superconductivity, CEBAF Technical Report, October 1993, Newport News, Va., R. M. Sundelin, Ed., p. 252]. Since heating the surface to 200° C. cannot account for the formation of jagged edges on a previously-smooth macroparticle, the interface between the macroparticle and the underlying surface appears to be affected by the heat treatment. The invention described below can affect the macroparticle-surface interface in a manner so as to decrease the emissivity of the metallic debris, thus reducing the field emission contribution to rf breakdown.

In summary, electrical breakdown is a serious problem in high-voltage applications. Existing solutions are either impractical, expensive, or non-existent. Current practice is to change the physical parameters (e.g., magnetic field, gap spacing) of the configuration, and in rf applications, to use single-layer coatings based upon carbon or titanium (e.g., TiN) to decrease the secondary-emission coefficient of the electrode. These coatings do not significantly reduce the field emission from the surface, and in fact, the carbon-based coatings can enhance field emission.

### SUMMARY OF THE INVENTION

The present invention pertains to a method of suppressing electrical breakdown on a surface of an object to reduce field emission. The method comprises the steps of applying a first coating layer to the surface; and applying at least one subsequent coating layer which does not cause cathode contamination to the a surface over the first coating layer.

The present invention pertains to a device comprising a component having a surface, a first layer in contact and covering the surface which has a dark current emission less than that of bare copper and a voltage breakdown threshold higher than 40 MV/m DC.

This invention consists of a coating applied to the metal surface which reduces the field emission levels of the surface. This coating could also decrease the secondary electron coefficient of the surface. The preferred embodiment described below is a hybrid coating consisting of two layers. However, a single-layer coating may also be used so long as it decreases field emission. Likewise, any number of coating layers may be used, so long as the resultant coating reduces field emission. The coating may also alter the properties of the interface between the metal surface and any macroparticle debris, in order to reduce field emission levels, but this is not essential, so long as the field emission from the surface is reduced. The invention is a coating which is not harmful to dc and rf vacuum system components, as for example, coatings which contain halogen atoms, such as CaF₂ [J. N. Smith, Jr., J. Appl. Phys. 59, 283 (1986)].

This invention provides a means of raising breakdown thresholds in rf cavities even in non-multipactor parameter regimes. The coating can reduce emission from the electrodes by isolating the electrode surface whiskers from the cavity vacuum (FIG. 1). It can also absorb low-energy secondary or field-emitted electrons.

Voltage holdoff data and dark current measurements for a variety of coatings have been obtained, two of which far exceed the properties of the current state-of-the-art Titanium Nitride (TiN) coatings. For example, DC electrical breakdown is increased from a value of 40 MV/m for bare Copper to 115 MV/m for a copper electrode coated as described in the preferred embodiment. TiN-coated electrodes undergo DC breakdown at a much lower value of 50 MV/m. Dark current levels from the coating described in the preferred embodiment are over six orders of magnitude less than TiN-coated Copper even after arcing. These coatings have been demonstrated to have the properties required for use in high-voltage holdoff applications. For example, they can decrease the secondary emission yield, are mechanically stable, are not sensitive to radiation, are bakeable (important since most vacuum electronic systems are baked before use to eliminate contaminants), do not affect the cavity Q (the ability of the cavity to store energy), and will not poison a cathode.

### BRIEF DESCRIPTION OF THE DRAWINGS

In the accompanying drawings, the preferred embodiment of the invention and preferred methods of practicing the invention are illustrated in which:

FIG. 1. Schematic drawing of electric field lines terminating on an electrode microprotrusion. The coating can reduce emission by isolating the whisker from the cavity chamber and absorbing the low-energy (secondary or field-emitted) electrons.

FIG. 2. Measured current in nA vs. electric field in MV/meter for the BN/TiN hybrid coating.

FIG. 3. Measured current in nA vs. electric field in MV/meter for the Si₃N₄/TiN hybrid coating.

FIG. 4. Comparison of field emission currents for Si₃N₄/TiN and bare Cu. The emitted current for Si₃N₄/TiN at 100 MV/m is less than 0.01 nA, while the emission from bare Cu is ⁻10 μA, or a difference of six orders of magnitude. Bare Cu sparks at 40 MV/m.

FIG. 5. Data before and after irradiation for the Si₃N₄ coating.

FIG. 6. Secondary electron yield for the chosen electrode coating, Si₃N₄/TiN. The measurements were taken with the FM Technologies, Inc. secondary electron test stand. The maximum yield is only ⁻1 at an energy of ⁻2 keV.

FIGS. 7a and 7b. Schematic representations of a perspective and cross-sectional view, respectively, of a component of the present invention.

### DESCRIPTION OF THE PREFERRED EMBODIMENT

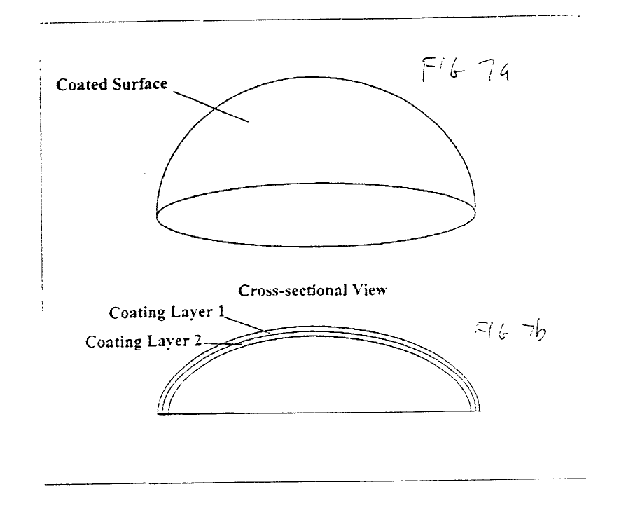

Referring now to the drawings wherein like reference numerals refer to similar or identical parts throughout the several views, and more specifically to FIGS. 7a and 7b thereof, there is shown a component of the present invention. The present invention pertains to a device comprising a component having a surface, a first layer in contact and covering the surface which has a dark current emission less than that of bare copper and a voltage breakdown threshold higher than 40 MV/m DC. Preferably, the surface is completely covered by the layer so no gaps exist through which voltage breakdown can occur.

The present invention pertains to a method of suppressing electrical breakdown on a surface of an object to reduce field emission. The method comprises the steps of applying a first coating layer coating to the surface; and applying at least one subsequent coating layer which does not cause cathode contamination to the surface over the first coating layer.

Preferably, at least one of the layers has a secondary emission ratio less than 2, and at least one of the layers has a dark current emission less than that of bare copper and a voltage breakdown threshold higher than 40 MV/m DC. One of the layers can be TiN, or Si₃N₄, or BN. One of the layers can be a semiconductor, an insulator, or a doped semiconductor. One of the layers can function as a substrate for growth of subsequent layers. Then, after the step of applying at least one subsequent layer, there is the step of growing another layer on the at least one layer.

This invention consists of applying a coating (a single- or multi-layer coating) onto a surface to decrease the field emission so as to increase the voltage holdoff and to decrease the dark current from that surface. The coating may also have a low secondary electron emission coefficient. Preferably, the thickness of each of the coating layers should be less than one hundred microns in order to ensure that important physical properties (for example, the cavity Q) be unchanged. However, any thickness that reduces field emission without significantly changing the cavity Q can be used with this invention. The application of each coating layer onto the surface, or onto another coating layer, can be accomplished using any suitable method known in the art [for example, ion implantation, sputtering, physical vapor deposition (PVD), chemical vapor deposition (CVD), plasma-assisted CVD, molecular beam epitaxy (MBE)].

The use of this invention provides many advantages as compared to other techniques known in the art. Such techniques include increasing the electrode gap, introducing transverse magnetic fields, outgassing, electrode conditioning, and even techniques that use a simple coating like lamp black or TiN to decrease secondary emission off the surface.

These other breakdown suppression techniques are impractical or do not work as well as this invention. Increasing the electrode gap or introducing transverse magnetic fields are usually not possible. Electrode conditioning or outgassing alone 4-4 cannot lower dark current levels or suppress voltage breakdown to the levels obtained with this invention.

While there has been little work on rf cavity coatings, there has been pioneering work done at SLAC [A. R. Nyaiesh, E. L. Garwin, F. K. King, and R. E. Kirby, J. Vac. Sci. Technol. A, 4, 2356 (1986); E. L. Garwin, F. K. King, R. E. Kirby, and O. Aita, J. Appl. Phys 61, 1145 (1987)] on using coatings to prevent multipacting on rf alumina windows. When too thin a layer of, for example, TiN, is used, secondary electron emission yields are not reduced enough to prevent multipacting. For alumina, the layer should be at least 0.5 nm. Conversely, if the layer is too thick, then excessive heating due to ohmic losses in the rf field both “evaporates” the coating and has also been observed to change the cavity Q (for alumina, for thicknesses greater than 1.5 nm).

The situation can be alleviated by using a hybrid coating in which is the first layer (for example, TiN) is a secondary electron inhibitor and additional layers (e.g., semiconductor or insulating layers) are inhibitors for field emission. This additional layer or layers are essential to reduce field emission because TiN coatings alone do not have significantly less field emission characteristics than the bare copper.

The examples presented below describe data that demonstrates the efficacy of two different multi-layer coatings: Si₃N₄/TiN and BN/TiN. Both coatings reduce voltage holdoff to levels much greater than is possible with existing methods and reduce dark current levels by six orders of magnitude below that of the bare metal. It is also demonstrated that these coatings are robust under conditions anticipated under use in vacuum systems and do not have deleterious effects on the cavity Q.

These examples are both multi-layer coatings, but a single material with low field-emission properties could be deposited on an electrode as a single layer. This material could also have a low secondary emission yield. It is also possible to envision multi-layer coatings in which one or more layers serve as substrates for the deposition of other layers. For example, TiN provides a much better substrate for Si₃N₄ than bare Cu.

The examples are not intended to describe all possible embodiments of this invention. Other coatings that fulfill the stated condition of reducing field emission wall be evident to those skilled in the art. The invention is limited only by the stated claims.

### EXAMPLE 1

A hybrid coating of BN/TiN can be deposited on a copper surface in the following manner: deposit 2.5 microns of TiN by ion implantation on the surface, and then deposit one micron of BN by sputtering on the TiN. This coating can increase the voltage holdoff of the surface to over 95 MV/m DC. Voltage holdoff in bare Cu is ⁻40 MV/m DC. Dark current levels for this coating are at least six orders of magnitude lower than bare Cu. This coating has been measured to have a small secondary electron yield, to be bakeable, and has been determined that it is mechanically stable and does not affect the cavity Q.

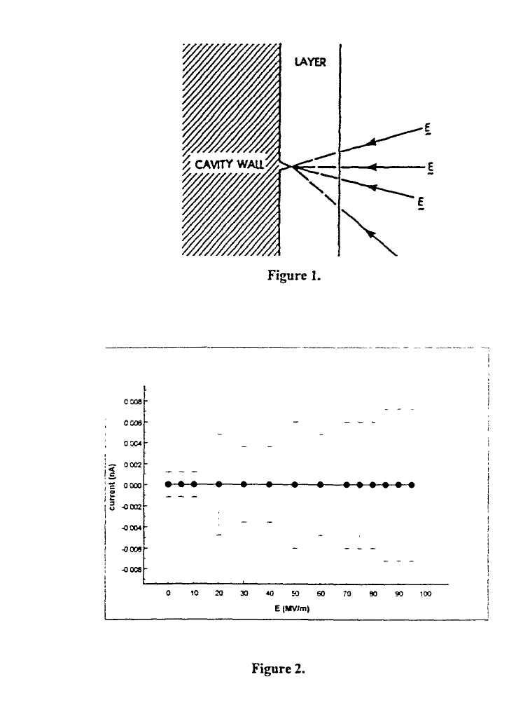

The BN/TiN coating was found to be rugged and the measurements were quite repeatable. The dark current levels from this coating are many orders of magnitude less than those for OFHC Copper and TiN coatings. In FIG. 2, there is shown a plot of current in nA vs. electric field in MV/m. It is seen that there is no measurable current up to 95 MV/m, after which the electrode exhibited a large current increase, i.e., sparking.

### EXAMPLE 2

A hybrid coating of Si₃N₄/TiN can be deposited on a copper surface in the following manner: deposit 2.5 microns of TiN by ion implantation on the surface, and then deposit one micron of Si N₄ by reactive sputtering on the TiN. This coating can increase the voltage holdoff of the surface to over 100 MV/m DC. Voltage holdoff in bare Cu is ⁻40 MV/m DC. Dark current levels for this coating are at least six orders of magnitude lower than bare Cu. This coating has been measured to have a small secondary electron yield, to be bakeable, and has been determined that it is mechanically stable and does not affect the cavity Q.

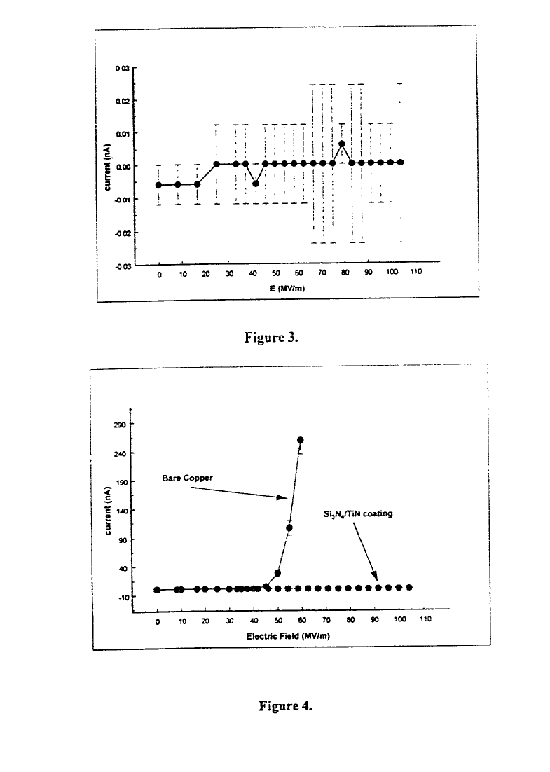

A one micron thick coating of Silicon Nitride on a 2.5 micron thick coating of Titanium Nitride had a breakdown field of 115 MV/meter. This coating has proved to be rugged and consistent. The dark current levels from this coating are many orders of magnitude less than OFHC Copper and TiN coatings. In addition, Si₃N₄/TiN has a low secondary emission ratio. In FIG. 3 we show a plot of current in nA vs. electric field in MV/m. It is seen that there is no measurable current up to 105 MV/m, after which the electrode exhibited a large current increase, i.e., sparking. It is also useful to plot the emission from bare Cu and to compare it with the results from Si₃N₄/TiN. The result is shown in FIG. 4.

Mechanical stability

Both of the coatings described in Examples 1 and 2 were tested for mechanical and thermal stability. These coatings were thermally cycled by raising their temperature from room temperature in a 10⁻⁹ torr vacuum to a baking temperature of 400° C. for 48 hours. Then the coatings were brought back down to room temperature and did not show any signs of flaking or change in mechanical and electrical properties.

Cavity Q effects

If an electromagnetic cavity is made up of these coated surfaces, it is important that the chosen coatings do not affect the Q of the cavity. For this purpose, an S-band cavity operating at 2775.7 MHZ for the TM₀₁₀ mode was designed and built. The cavity was made of OHFC copper and had an SMA connector in the center of the flat cover. The cavity Q was measured with an HP 8753A Network Analyzer by a connector assembly consisting of a cable attached to one SMA bulkhead feedthrough. The measured Q was 3521±50.

The cavity Q with the Si₃N₄/TiN coating was measured and was found to be approximately that of the bare OFHC copper. The resonant frequency of the cavity was also the same.

Radiation effects

In klystron environments, the electrode coatings will be exposed to high doses of radiation. Since the klystrons are insulated from the radiation in the accelerator, the bulk of the radiation comes from the klystron beam. The radiation dose rate at the cavity is estimated to be ⁻1 rad/hr. Assuming that the accelerator is kept on for 25,000 hours, one finds that the dose is approximately 25,000 rads or 25 krads.

To test the effect of radiation on coatings, the current vs. electric field up to an electric field of 85 MV/m was measured for a Si₃N₄/TiN hybrid-coated Cu disk. No observable current (<10 pA) could be detected. This was consistent with previous measurements of Si₃N₄/TiN hybrid-coated Cu disks. The disk was then irradiated with a hot Co⁶⁰ radiation source which can output ⁻100 gray/min, or 10 krads/min. The energy of the gammas was approximately 1.25 MeV. At such a radiation output, a time of 2.5 minutes is enough to provide a dose of 25 krads. However, the 1.25 MeV energy is higher than a typical value of ⁻500 keV that would be realized in a klystron. The atomic number Z of Cu is 29, and the mass absorption coefficient of gamma rays on Cu gives a factor of exp(0.03) ⁻1.03 for absorption of 1.25 MeV gamma rays as opposed to 500 keV. The correction factor is not far from unity so that one can safely ignore the energy difference between the Co radiation source and that found in a real klystron. Based on this calibration, the coating was irradiated for 5.6 minutes to obtain a total dosage of 50,000 rads (50 krads). The disc was placed into the radiation source which was a Gammacell-220 machine manufactured by Atomic Energy of Canada, Ltd. The disc was placed on top of a thick plastic holder with the coated side first upside down and then right side up, for 2.8 minutes each.

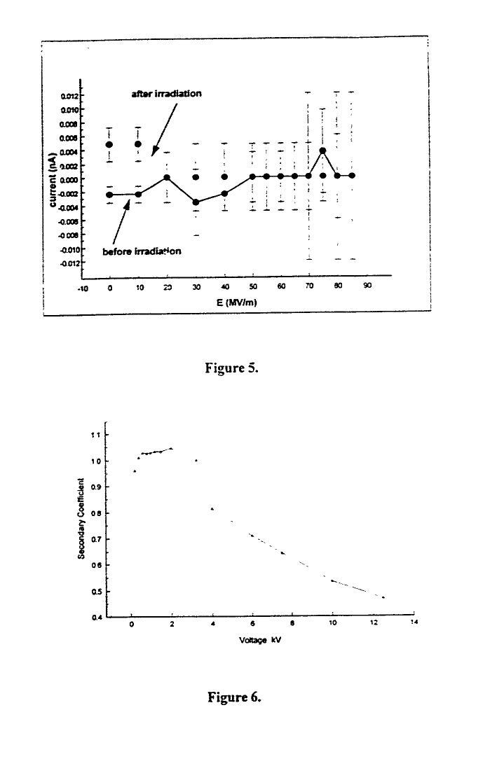

FIG. 5 shows data for the measurements that were made on a Si₃N₄/TiN hybrid-coated Cu disk before and after the irradiation. As can be seen in FIG. 5, the coating showed no effects from the radiation.

Secondary Electron Yield

The Silicon Nitride/Titanium Nitride hybrid coating was tested for secondary electron emission properties. In FIG. 6 we Otto show a plot of the secondary electron yield of the Si₃N₄/TiN sample, which was an OFHC Cu disk with 2.5 microns of TiN, and with one micron of Si₃N₄ on top. As seen in the figure, the maximum yield of Si₃N₄/TiN is only a little larger than unity at an energy of ⁻2 keV. Thus, in addition to reducing field emission, this coating K also has a low secondary emission ratio.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A method of suppressing electrical breakdown on a surface of an object to reduce field emission comprising the steps of:
applying a first coating layer to the surface; and
applying at least one subsequent coating layer which does not cause cathode contamination to the surface over the first coating layer.

2. A method as described in claim 1 wherein at least one of the layers has a secondary emission ratio less than 2.

3. A method as described in claim 1 wherein at least one of the layers has a dark current emission less than that of bare copper and a voltage breakdown threshold higher than 40 MV/m DC.

4. A method as described in claim 1 in which at least one of the layers is TiN.

5. A method as described in claim 1 in which at least one of the layers is Si₃N₄, or BN.

6. A method as described in claim 1 in which at least one of the layers is a semiconductor, an insulator, or a doped semiconductor.

7. A method as described in claim 1 in which at least one of the layers functions as a substrate for growth of subsequent layers; and after the step of applying at least one subsequent step, there is the step of growing another layer on the at least one layer.

8. A device comprising a component having a surface, a first layer in contact and covering the surface which has a dark current emission less than that of bare copper and a voltage breakdown threshold higher than 40 MV/m DC.
